(19) United States
(12) Patent Application Publication
(10) Pub. No.: US 2010/0153897 A1
(43) Pub. Date: Jun. 17, 2010

(54) SYSTEM AND METHOD FOR EMPLOYING SIGNOFF-QUALITY TIMING ANALYSIS INFORMATION CONCURRENTLY IN MULTIPLE SCENARIOS TO REDUCE LEAKAGE POWER IN AN ELECTRONIC CIRCUIT AND ELECTRONIC DESIGN AUTOMATION TOOL INCORPORATING THE SAME

(75) Inventor: Bruce E. Zahn, Allentown, PA (US)

Correspondence Address: HITT GAINES, PC;LSI Corporation, PO BOX 832570, RICHARDSON, TX, 75083, US

(73) Assignee: LSI Corporation, Milpitas, CA (US)

(21) Appl. No.: 12/333,288

(22) Filed: Dec. 11, 2008

(51) Int. Cl. G06F 17/50

(52) U.S. Cl. 716/9; 703/19

(57) ABSTRACT

A leakage power recovery system and method, and a electronic design automation (EDA) tool incorporating either or both of the system and the method. In one embodiment, the timing signoff tool includes: (1) a power recovery module configured to carry out an instance of an initial power recovery process in each of multiple scenarios concurrently, the initial power recovery process including making first conditional replacements of cells in at least one path in a circuit design with lower leakage cells and estimating a delay and a slack of the at least one path based on the first conditional replacements and (2) a speed recovery module associated with the power recovery module and configured to carry out a speed recovery process in each of the multiple scenarios concurrently, the speed recovery process including determining whether the first conditional replacements cause a timing violation with respect to the at least one path and making second conditional replacements with higher leakage cells until the timing violation is removed.

### CROSS-REFERENCE TO RELATED APPLICATION

This application is related to U.S. patent application Ser. No. 12/198,030, filed by Zahn on Aug. 25, 2008, entitled “System and Method for Employing Signoff-Quality Timing Analysis Information to Reduce Leakage Power in an Electronic Circuit and Electronic Design Automation Tool Incorporating the Same,” commonly assigned with this application and incorporated herein by reference.

### TECHNICAL FIELD

The invention is directed, in general, to integrated circuits (ICs) and, more specifically, to a system and method for employing signoff-quality timing analysis information concurrently in multiple scenarios to reduce leakage power in an electronic circuit, particularly an IC, and an electronic design automation (EDA) tool incorporating the same.

### BACKGROUND

Power consumption is a concern in most circuit designs, particularly those that are to be battery-powered. Circuit designs should achieve the lowest possible power consumption while achieving defined performance targets. Timing is a major concern in all IC designs, because circuits will not operate properly unless signals can propagate properly through them. Consequently, “timing signoff” is a required step in the designing of a circuit, particularly an IC, and involves using a signoff analysis tool to determine the time that signals will take to propagate through the circuit. If propagation time is inadequate, critical paths in the circuit may have to be modified, or the circuit may have to operate at a slower speed. Power and timing objectives are often at odds; faster devices usually require more power than slower devices, and vice versa.

Electronic design automation (EDA) tools, a category of computer aided design (CAD) tools, are used by electronic circuit designers to create representations of the cells in a particular circuit and the conductors (called “interconnects” or “nets”) that couple the cells together. EDA tools allow designers to construct a circuit design and simulate its performance using a computer and without requiring the costly and lengthy process of fabrication. EDA tools are indispensable for designing modern, very-large-scale integrated circuits (VSLICs). For this reason, EDA tools are in wide use.

Many EDA tool companies offer EDA tools that perform both power and timing optimization. These combined power and timing optimization tools employ approximate circuit models and parameters to represent the circuit design and are used well before timing signoff. Timing signoff then becomes an iterative process of using the signoff analysis tool to analyzing timing on an accurate representation of the finished circuit design, reoptimizing for power and timing using the combined optimization tool and reanalyzing using the signoff analysis tool until further optimization becomes unfruitful. Some EDA tool companies offer power optimization tools that run in conjunction with the signoff analysis tool. However, these power optimization tools must be integrated into timing signoff, requiring users to purchase and learn the additional power optimization tool to design a circuit and creating coordination issues between the power optimization tool and the signoff analysis tool which require additional turnaround time to resolve. Such power optimization tools also do not readily adapt to requirements specific to a particular circuit design.

### SUMMARY

To address the above-discussed deficiencies of the prior art, one aspect of the invention provides a timing signoff tool. In one embodiment, the timing signoff tool includes: (1) a power recovery module configured to carry out an instance of an initial power recovery process in each of multiple scenarios concurrently, the initial power recovery process including making first conditional replacements of cells in at least one path in a circuit design with lower leakage cells and estimating a delay and a slack of the at least one path based on the first conditional replacements and (2) a speed recovery module associated with the power recovery module and configured to carry out a speed recovery process in each of the multiple scenarios concurrently, the speed recovery process including determining whether the first conditional replacements cause a timing violation with respect to the at least one path and making second conditional replacements with higher leakage cells until the timing violation is removed.

Another aspect of the invention provides a leakage power recovery method. In one embodiment, the method includes: (1) making first conditional replacements of cells in at least one path in a circuit design with lower leakage cells, (2) estimating a delay and a slack of the at least one path based on the first conditional replacement, (3) determining whether the first conditional replacements cause a timing violation with respect to the at least one path, (4) making second conditional replacements with higher leakage cells until the timing violation is removed and (5) merging and applying the swaps and updating timing with respect to the each of the multiple scenarios.

### BRIEF DESCRIPTION

Reference is now made to the following descriptions taken in conjunction with the accompanying drawings, in which:

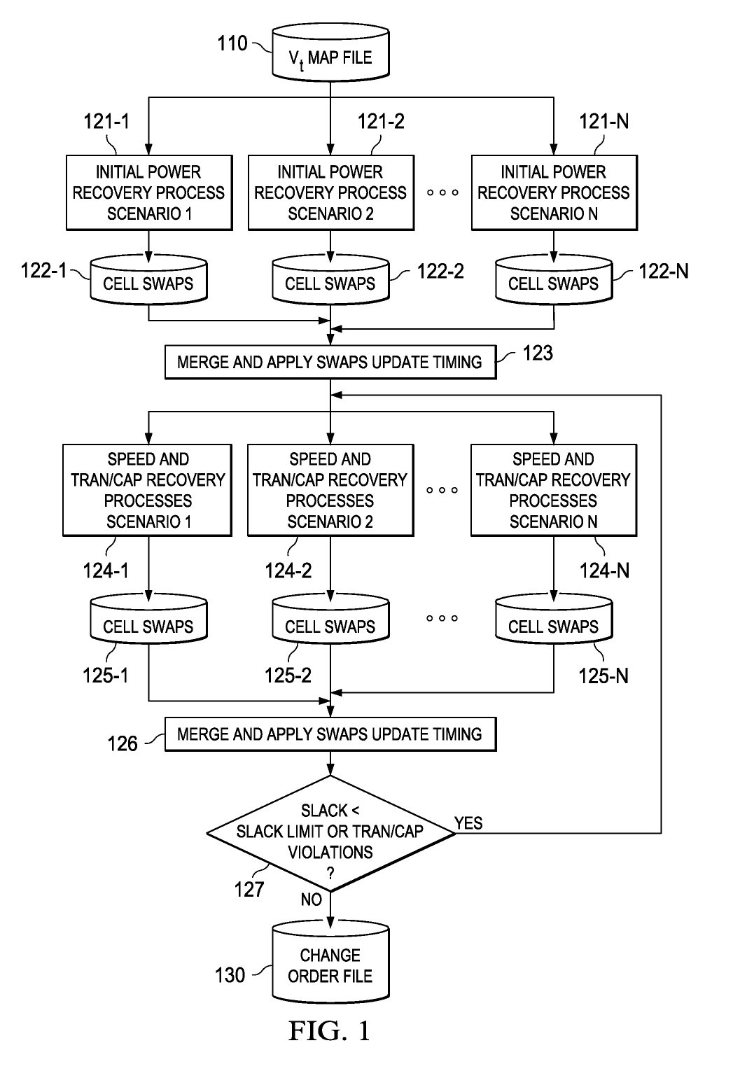

FIG. 1 is a high-level block diagram of one embodiment of a leakage power recovery system and method carried out according to the principles of the invention;

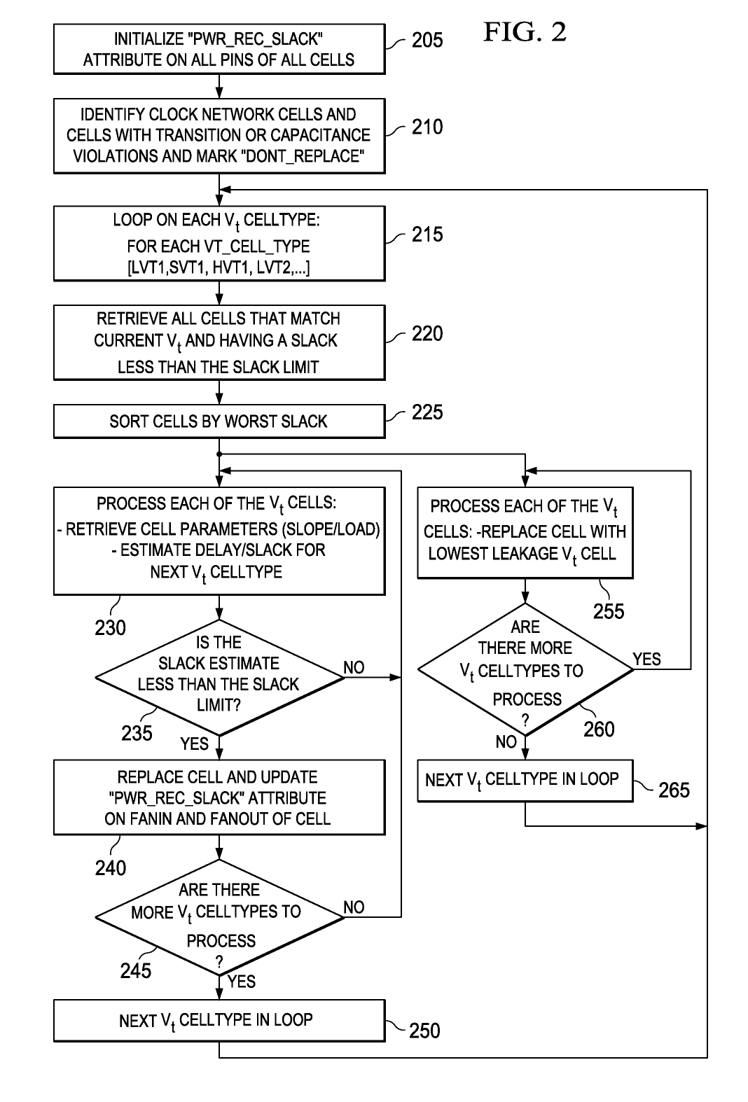

FIG. 2 is a flow diagram of one embodiment of one instance of a power recovery process carried out in the method of FIG. 1;

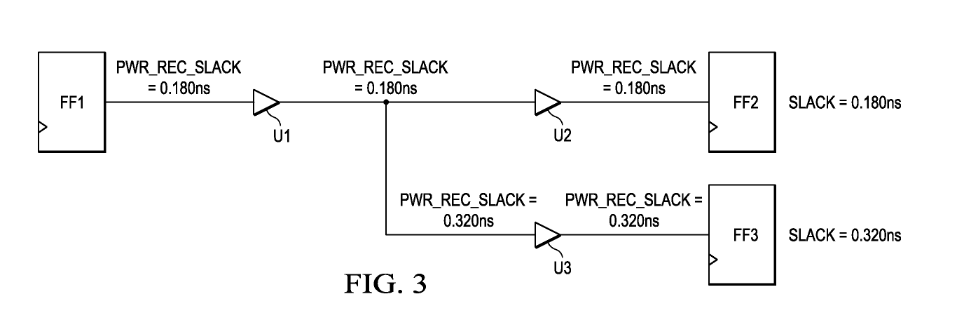

FIG. 3 is a schematic diagram of a portion of an example circuit illustrating operation of the power recovery process of FIG. 2;

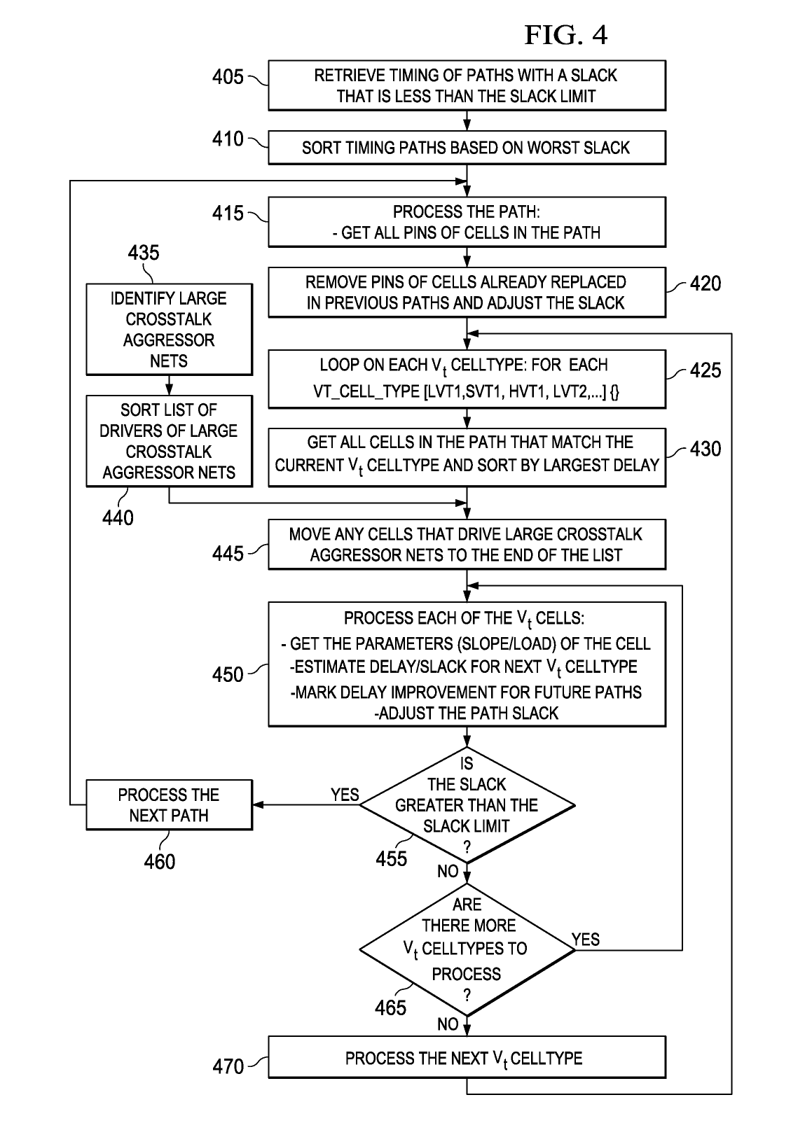

FIG. 4 is a flow diagram of one embodiment of one instance of a speed recovery process carried out in the method of FIG. 1;

FIG. 5 is a schematic diagram of a portion of an example circuit prior to operation of the speed recovery process of FIG. 4; and

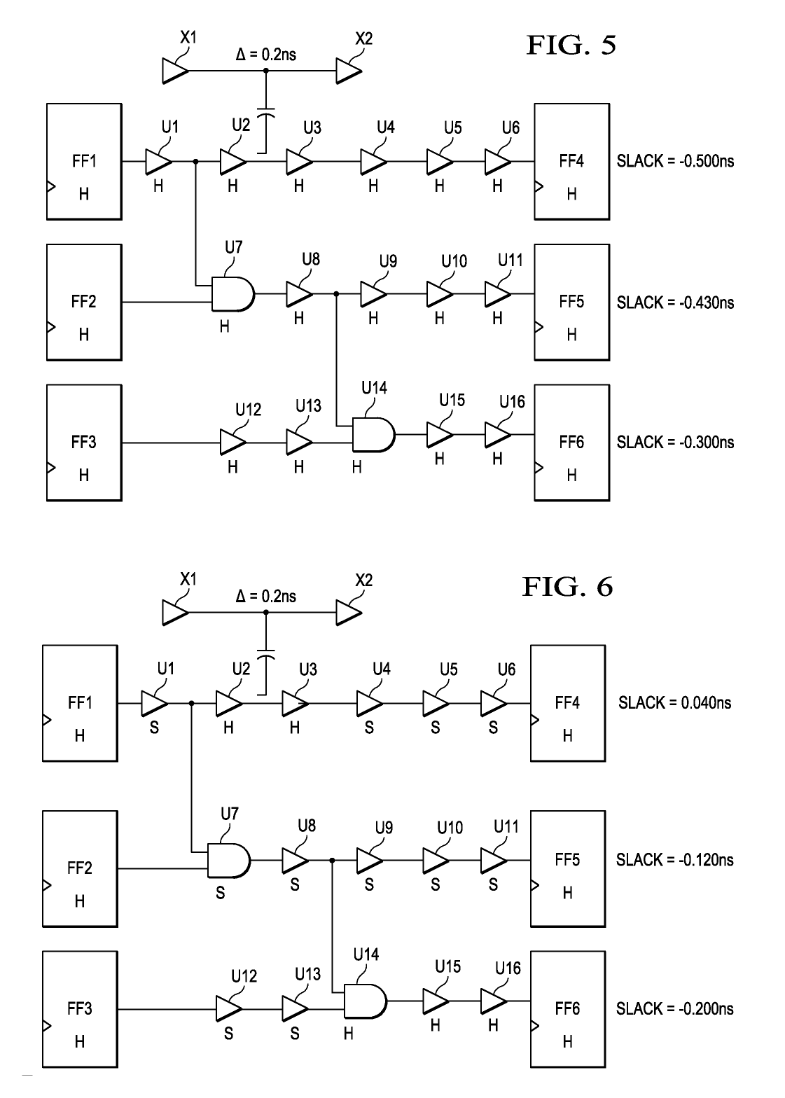

FIG. 6 is a schematic diagram of a portion of an example circuit following operation of the speed recovery process of FIG. 4.

### DETAILED DESCRIPTION

Described herein are various embodiments of an EDA tool and method for employing signoff-quality timing analysis information to reduce leakage power in an electronic circuit, such as an IC. One embodiment of the method, referred to herein as a leakage power recovery method, is carried out during timing signoff to achieve improved, perhaps optimal, leakage power levels while preserving the timing performance of the circuit design. The leakage power recovery method analyzes the timing of a circuit design and replaces higher leakage cells with lower leakage cells on paths with a positive timing margin. The lower leakage cells are inherently slower, but the leakage power recovery method determines how many lower leakage cells can be used without adversely affecting performance targets.

Unlike the conventional combined optimization tool described above, the novel system and method described herein operate with an accurate representation of the finished circuit design such that an iterative approach to leakage recovery is no longer required. Unlike the conventional power optimization tools that run in conjunction with a signoff analysis tool, no integration or additional costs or learning time is needed, coordination issues between the power optimization tool and the signoff analysis tool need not exist, and the leakage power recovery method readily adapts to requirements specific to a particular circuit design.

The illustrated embodiments of the leakage power recovery system and method are carried out as part of timing signoff. A signoff analysis tool, called Primetime-SI® (commercially available from Synopsys, Inc., of Mountain View, Calif.), will be referenced for purposes of describing the leakage power recovery system and method. In fact, most described embodiments of the leakage recovery system and method are carried out ancillary to or from within Primetime-SI®. However, those skilled in the pertinent art will recognize that the leakage power recovery method may be used with or in any conventional or later-developed signoff analysis tool.

Certain embodiments described herein employ the Distributed Multi-Scenario Analysis (DMSA) feature of Primetime-SI®. The DMSA feature allows timing analysis to be done in a distributed manner in multiple threads or on multiple computers for multiple corners or operating modes. These multiple threads or multiple computers may be regarded as slave processes. Each corner or mode is called a “scenario” and represents an independent Primetime-SI® run at a particular corner or mode. A master process in Primetime-SI® receives information from the slave processes, merging the results of the timing analyses performed thereby. Those skilled in the pertinent art will recognize that other conventional or later-developed signoff analysis tools may have features similar to DMSA; the principles described herein extend to such features.

According to the leakage power recovery system and method, the timing of a circuit design is analyzed, and cells exhibiting a higher leakage (typically those having a lower threshold voltage, or Vₜ, sometimes referred to as Vth or vth) are replaced with cells exhibiting a lower leakage (typically those having a higher Vₜ) on paths with a positive timing margin, i.e., non-critical paths. The lower leakage cells are inherently slower to switch, but the leakage power recovery system and method can determine how many can be used in lieu of higher leakage cells without compromising performance targets. The leakage power recovery system and method is typically run on a circuit design late in the design process after the design timing is closed, in other words, after the circuit design has been determined to meet its performance goal. In one embodiment, higher leakage cells are replaced with lower leakage cells having an equivalent footprint as the higher leakage cells they replaced, such that replacement can occur without disturbing the layout routing at all. Processing multiple scenarios concurrently may result in faster optimization times.

FIG. 1 is a high-level block diagram of one embodiment of a leakage power recovery system and method carried out according to the principles of the invention. The input to the leakage recovery system and method is a voltage threshold (Vₜ) map file 110 and a user-defined slack limit. The illustrated embodiment of the Vₜ map file 110 lists different Vₜ library names and cell prefixes in order from those having the largest leakage (and the fastest timing) to those having the smallest leakage (and the slowest timing) for each scenario. The objective of the signoff analysis is to perform leakage recovery while ensuring that timing performance does not fall below the user-defined slack limit. This is done based on the order specified in the Vₜ map file 110. A portion of an example Vₜ map file 110 is as follows:

scenario_name G65fp:FP g65p:P g65lp:LP
scenario_name G65fpipo:FP g65pipo:P g65lpipo:LP

In the illustrated embodiment, the Vₜ map file 110 is formatted such that one set of libraries is set forth per line. Each line contains a space-separated list of scenario name followed by library_name: vth_suffix ordered from the fastest, highest leakage celltype to the slowest, lowest leakage celltype.

In the embodiment of FIG. 1, a timing signoff tool performs a signoff analyses 120 concurrently for each of at least two corners or modes: Scenario 1, Scenario 2, . . . , Scenario N in the illustrated embodiment.

A corner represents particular assumptions regarding circuit fabrication or operating voltage or temperature variables. For example, variations in feature size and physical characteristics caused by expected variations in a normal fabrication process may cause Vₜ to vary over the area of a given IC (so-called “in-chip variations, or ICV) or from one IC to another. Likewise, variations in operating voltages or temperatures may cause cells to propagate transitions faster or slower. An analysis performed in a “slow corner” is therefore undertaken assuming that cells operate as slowly as possible given a normal fabrication variations and relatively low operating voltages and temperatures. Analyses may also be performed in average or fast corners. Corners may therefore be thought of as, e.g., worst, typical and best cases for analysis. All corners, and not just the process, voltage and temperature (PVT) corners described above, fall within the broad scope of the invention. In the illustrated embodiment, one of the corners (Scenario 1, Scenario 2, . . . , Scenario N) is a slow corner.

In the illustrated embodiment, the system includes four recovery modules: a power recovery module, a speed recovery module, a transition recovery module and a capacitance recovery module. The power recovery module is configured to carry out an instance of an initial power recovery process for each of multiple scenarios (i.e., Scenario 1, Scenario 2, . . . , Scenario N) concurrently, viz., initial power recovery processes 121-1, 121-2, . . . , 121-N. Cells are substituted on the basis of the initial power recovery processes in corresponding instances of cell swap processes 122-1, 122-2, . . . , 122-N are carried out concurrently for each of the scenarios. Repeating the initial power recovery processes 121-1, 121-2, . . . , 121-N over multiple scenarios may be particularly advantageous for circuits having multiple modes of operation. The circuit is likely to have a corner, e.g., a slow corner, in each mode that would benefit from a power recovery process carried out according to the principles of the invention. The cell swaps are then merged and applied, and a timing update is performed as indicated in a process 123.

Slack is defined as the difference between the time required for a transition to propagate from the start to the end of a particular path and the time required for a transition to propagate from the start to the end of the slowest path that terminates at the same end as the particular path (the “critical path”). A positive slack indicates the degree to which the particular path is faster than the critical path. A negative slack indicates the degree to which the particular path is slower than the critical path. A slack limit is a positive number that a user defines to be any desired value, e.g., 0.20 ns.

In one embodiment, the initial power recovery processes 121-1, 121-2, . . . , 121-N identify all clock cells and cells that have timing below the user-defined slack limit provided and marks these as “don't_replace.” All remaining constrained cells are then analyzed to determine if they could be replaced to achieve better leakage optimization. The initial power recovery processes 121-1, 121-2, . . . , 121-N estimate delay slowdowns to avoid timing updates and thereby reduce runtime. After all cells are processed, cell replacements are applied, and a timing update then occurs. After a timing update, timing failures, transition violations, and capacitance may then be determined. Timing failures may result from, for example, timing estimates that are based on limited factors (e.g., in input transition or output load), replaced cells that have different pin capacitance and drive capability and crosstalk effects that may not be accounted for during delay estimation.

The speed, transition and capacitance recovery modules are respectively configured to carry out configured to carry out an instance of a speed, transition and capacitance recovery process for each of multiple scenarios (i.e., Scenario 1, Scenario 2, . . . , Scenario N) concurrently, viz., speed, transition and capacitance recovery processes 124-1, 124-2, . . . , 124-N. After the power recovery module has carried out the initial power recovery processes 121-1, 121-2, . . . , 121-N, the speed recovery module may perform multiple iterations of the speed recovery processes in each scenario to repair any timing that is below a user-defined slack limit. In one embodiment, each iteration of each instance of the speed recovery process loops through the failing timing paths, replacing the minimum amount of cells to repair the timing while preserving the best leakage power.

After the speed recovery processes are performed as part of the processes 124-1, 124-2, . . . , 124-N, the transition and capacitance recovery processes are carried out as part of the processes 124-1, 124-2, . . . , 124-N to analyze any transition and capacitance violations that may have been introduced during the initial power recovery processes 121-1, 121-2, . . . , 121-N. In the embodiment of FIG. 1, the transition and capacitance recovery processes are conventional processes carried out in a signoff analysis tool. However, those skilled in the pertinent art will understand that later-developed transition and capacitance recovery processes fall within the broad scope of the invention.

Cells are again substituted on the basis of the speed, transition and capacitance recovery processes in corresponding cell swap processes 125-1, 125-2, . . . , 125-N that occur concurrently in each of the scenarios. The cell swaps are then merged and applied, and a timing update is performed as indicated in a process 126. A slack limit and transition and capacitance violation test is applied in a process 127. If the test is failed (signified by the YES branch), the speed, transition and capacitance recovery processes 124-1, 124-2, . . . , 124-N are carried out again as indicated. If the test is passed, an engineering change order (ECO) file 130 may then be produced. The ECO file 130, if implemented, is expected to yield a circuit that exhibits at least some degree of leakage optimization while meeting the performance target.

Embodiments of the Power Recovery Process

FIG. 2 is a flow diagram of one embodiment of one instance of the initial power recovery process carried out in the system and method of FIG. 1. The illustrated embodiment of the power recovery process in the power recovery process has two effort levels, low and high. These different effort levels represent a tradeoff between runtime and leakage recovery improvement. Power recovery can take long runtimes, and some circuit designs can not accommodate long runtimes in their schedule. Other circuit designs are so power sensitive that long runtimes are always justified. Therefore, alternative embodiments have only one of the two effort levels.

In general, for the low effort level, the power recovery process examines cells in the design and their timing slack to determine if cells can be replaced with lower leakage cells without reducing the timing slack below the user-defined slack limit. First, in a step 205, every pin in the Vₜ map file 110 of FIG. 1 is initialized with an attribute called “pwr_rec_slack.” This attribute contains the worst timing slack value (rise or fall) that any timing path through that a pin encounters. For example, FIG. 3 is a schematic diagram of a portion of an example circuit illustrating operation of the power recovery process of FIG. 2. FIG. 3 contains two timing paths that include the output pin “U1/Z.” One path starts at FF1 and ends at FF2 with a timing slack of 0.180 ns, and another path starts at FF1 and ends at FF3 with a timing slack of 0.320 ns. Since the worst timing slack through the output pin “U1/Z” is 0.180 ns, its pwr_rec_slack attribute is set to 0.180 ns. The output pin “U3/Z” has a worst timing slack set to 0.320 ns.

After the design is initialized with these “pwr_rec_slack” attributes in the step 205, clock network cells and cells with transition or capacitance violations, e.g., those that have an initial starting timing slack below the user-defined slack limit or cells that are unconstrained. A cell that is unconstrained does not contain a timing slack value since it is constrained in another mode of analysis. Every such cell is marked “don't_replace” in a step 210; only cells not marked “don't_replace” are then processed. A loop is undertaken in a step 215 for each Vₜ celltype. All cells of that celltype are retrieved from the Vₜ map file 110 in a step 220. Cells are sorted by slack in a step 225. In the illustrated embodiment, the cells are sorted by ascending slack, such that those having the least (worst) slack are at the top of the list and those having the greatest slack are at the bottom of the list.

As each cell is processed, the input transition ramp time and output load capacitance are identified in a step 230. Using these parameters, it is possible to estimate how much each cell would slow down if it were replaced with the next level lower leakage Vₜ cell. If the estimated slowdown results in a timing slack that is still above the user-defined slack limit (determined in a decisional step 235), the replacement is scheduled to be made in a step 240. In the step 240, the “pwr_rec_slack” attributes of all pins in the transitive fanout of the pin being processed are then updated to reflect this slow down, and the transitive fanin to each of the cell's input pins are examined to see if their “Dwr_rec_slack” attributes should be updated. Each of the “pwr_rec_slack” attribute of the pins in the transitive fanin is updated if its value is equal to the original cell's “pwr_rec_slack” value. The reason that only the pins with a “pwr_rec_slack” attribute equal to the current cell's input pin “pwr_rec_slack” attribute are modified is to ensure that the fanin pins are on the worst path. If a fanin pin does not have the same “pwr_rec_slack” value, it is involved in a different worst path and is not modified. For example, with reference to FIG. 3, assuming “U3” is being replaced with a slower Vₜ cell and therefore being slowed down by 0.050 ns. It would not be correct to adjust the “pwr_rec_slack” value on the output pin of “U1” because its worst path is still the path from FF1 to FF2 has a slack of 0.180 ns. Without incurring a timing update, it is not possible to update all the slack attributes in the design. Therefore only updating the ones that are equal to the pin of the cell being processed ensures these are on the same worst path.

The loop is repeated via the decisional step 245 and the step 250 for each cell of that celltype and then for each celltype in the circuit until all cells of all celltypes have been processed.

For the high effort level, it has been seen that on many circuit designs better power recovery results can be obtained by converting all cells (except clock network cells and those having slacks that are greater than the user-defined slack limit) to be the lowest leakage Vₜ cells in a step 255. In doing so, the timing performance of the design shows many more violating paths that need to be repaired in the speed recovery process. Since the speed recovery process processes timing paths, it has more accurate information, such as transition rise and fall delays and timing slacks. This more accurate data allows a better leakage recovery result with this high effort approach. However, this is typically achieved at the cost of additional runtime. The loop is repeated via the decisional step 260 and the step 265 for each cell of that celltype and then for each celltype in the circuit until all cells of all celltypes have been processed.

The result of the power recovery process is a list of cell replacements that should be implemented. The timing of the circuit design is then updated. This update likely causes timing (speed) violations, transition violations and capacitance violations. At this stage multiple iterations of speed recovery are performed to repair any timing that is below the user-defined slack limit.

Embodiments of the Speed Recovery Process

FIG. 4 is a flow diagram of one embodiment of one instance of a speed recovery process carried out in the system and method of FIG. 1. The illustrated embodiment of the speed recovery process analyzes failing paths to perform footprint-equivalent Vₜ cell replacements to repair the timing of the design while preserving the best leakage power. The speed recovery process retrieves the timing of failing paths in a step 405 sorts the failing paths for each clock group by worst (least) timing slack in a step 410. For each path, the pins of the cells in the path are retrieved in a step 415. Pins of cells already replaced by the speed recovery process (due to their being in previously processed paths) are removed in a step 420, and the slack is adjusted accordingly. In a step 425, a loop is undertaken for each Vₜ celltype in the path. Information regarding all cells in the path of a given Vₜ celltype are retrieved in a step 430 and sorted into a list based on delay. In the illustrated embodiment, the cells are sorted by descending delay.

FIG. 5 is a schematic diagram of a portion of an example circuit prior to operation of the speed recovery process of FIG. 4, which will be used to understand the illustrated embodiment of the speed recovery process. In this circuit, celltypes are “H,” “S” and “L₊” The “H” celltype refers to a relatively high Vₜ cell that propagates transitions relatively slowly but has a relatively low leakage. The “S” celltype refers to a standard Vₜ cell that propagates transitions faster than the “H” celltype but also has a higher leakage than the “H” celltype. The “L” celltype refers to a relatively low Vₜ cell that propagates transitions relatively quickly but has a relatively high leakage. The speed recovery process can support any number of Vₜ celltypes, but this example is limited to these three celltypes. Assume that after the power recovery process, using a high effort level, all cells have been replaced with the “H” celltype.

The illustrated embodiment of the speed recovery process also takes into consideration cells that are crosstalk aggressors of crosstalk victim nets. The cells that drive crosstalk aggressor nets (those having crosstalk exceeding a threshold) are handled differently to minimize the introduction of additional crosstalk delay variation on victim nets, which can degrade timing. Those skilled in the pertinent art are aware of how to calculate the degree to which nets are responsible for crosstalk with adjacent nets.

Before processing the failing paths of the circuit design, an analysis is done in a step 435 to identify the largest crosstalk aggressor nets of victim nets involved in failing timing paths. Large crosstalk aggressor nets are sorted in a step 440. In a step 445, the cells that drive the large aggressor nets are moved to the bottom of the sorted list. In the illustrated embodiment, crosstalk aggression is used as a cost factor when processing paths to determine the best candidates to replace faster cells with higher leakage and discourages the replacement of a cell that is an aggressor to many victim nets.

In the example circuit of FIG. 5, the worst timing path is from FF1 to FF4 with a timing slack of −0.500 ns. The next worst path is from FF1 to FF5 with a timing slack of −0.430 ns and so on. Notice that certain endpoint flip flops such as FF5 and FF6 have multiple timing paths from different starting points. For example FF5 has two timing paths, one from FF1 and one from FF2. Turning back to FIG. 4, the speed recovery process loops on failing timing paths and sorts them by the worst timing slack. When processing the worst timing path the speed recovery process loops through each pair of Vₜ celltypes. For the example of FIG. 5, the replacement pairs are “H to S” and “S to L.” So when processing the FF1 to FF4 path, all the cells of celltype “H” are collected. These cells are sorted in descending order of cell delay. Any cells that have been identified earlier as being involved as crosstalk aggressors are put to the bottom of the sorted list. For example instance U2 is an aggressor to the net driven by instance “X1” and is therefore considered last for cell replacement to avoid increasing the aggression. Each of these cells is then processed to get its input transition and output load in a step 450. Based on these parameters, an estimated delay is obtained for the next faster more leakage celltype in the step 450. The timing slack is then adjusted by the delay improvement of this replacement in the step 450. Additional cells are processed unless the timing slack becomes greater than the user-defined slack limit (as determined in the decisional step 455, which reiterates the loop via the step 460). This ensures the minimum number of replacements to higher leakage cells to meet the timing performance target.

The delay improvement estimate is stored on the output pin of the cell scheduled to be replaced. This is done so that if this cell is involved in other timing paths the slack can be adjusted before any new cells in the timing path are processed. For example, while processing path FF1 to FF4, U1 is marked to be replaced and this result is a 0.050 ns faster delay on U1. This delay is stored on the output pin of U1. When the FF1 to FF5 path is processed the speed recovery process first checks if any cells have been replaced from a previous path and adjusts the slack by the delay improvement. In this case the slack value would be adjusted by the 0.050 ns improvement from U1. When the cells in a path are being processed, a cell is replaced only if it was changed previously during the power recovery process. This is to ensure that hold violations are not introduced.

After all the “H” cells are processed in the path being examined, all the next celltype (“S” celltype) will then be processed via the decisional step 465 and the step 470. The speed recovery process only changes celltypes by one level. This is because it is working on delay estimates and a timing update is required to get an accurate assessment of the timing performance of the design. After the failing paths are processed, the scheduled replacements are performed, and a timing update occurs.

FIG. 6 is a schematic diagram of a portion of an example circuit following operation of the speed recovery process of FIG. 4. After the speed recovery iteration the circuit may have been updated to have the cell mix as shown in FIG. 6. The timing on many paths has been repaired, such as the path going to FF4. The path from FF1 to FF5 has improved but needs additional cell replacements to “L” celltypes. This would occur in subsequent speed recovery iterations. The path from FF1 to FF6 was most likely never reached since some “H” celltypes still exist in this path. This path will also be examined in subsequent iterations.

In the illustrated embodiment, multiple iterations of the speed recovery routine are run to repair the entire timing of the circuit design. To reduce runtime, the number of failing paths processed may be chosen carefully. Processing all failing paths may consume too much runtime and lead to diminishing improvement if many of the cells in the failing paths have been processed earlier. This can also be design-specific as some designs may have deep combinational logic (such as multiplexing) to specific endpoints.

The speed recovery process may use different techniques to handle the number of failing paths to process. In one embodiment, the speed recovery process collects failing paths based on a limit of 1 million paths per clock group, and a limit of 30 paths per endpoint flip flop (these parameters can be changed by the user based on celltype of design). In another embodiment, the speed recovery process collects failing paths based on the start flip flop to end flip flop pair connectivity. In the latter embodiment, only one path per start flip flop to end flip flop pair is obtained. Due to the number of flip flops in a circuit design this can result in a large number of paths. In either case a limit on the maximum paths processed per iteration is used (default 500,000). In yet another embodiment, the speed recovery process alternates between these two techniques for each iteration of the speed recovery process. This yields a relatively robust technique for path collection that covers various design structures.

After all the speed recovery process iterations are complete the timing should be repaired to the user-defined slack limit. In some cases, due to timing window shifts arising from cell replacements, additional crosstalk delay variation may be seen on certain paths. For example, a path may have been put back to the identical celltypes prior to the leakage recovery speed recovery process being run but fail timing due to additional crosstalk delay variation. To handle this situation, additional speed recovery iterations can be run ignoring the function of only changing cells that were replaced originally during the power recovery process. This will repair any remaining timing issues, but hold timing must be checked to ensure a hold issue is not introduced.

Transition and Capacitance Recovery

After the speed recovery portion is completed the speed recovery process identifies any transition and capacitance violations that were introduced by cell replacement performed during the power recovery process. The driver cells on transition violations are replaced with cells that have sharper transition times. Similarly cells with maximum capacitance violations are changed back to cells that can drive a larger load.

Certain embodiments of the invention further relate to computer storage products with a computer-readable medium that have program code thereon for performing various computer-implemented operations that embody the tools or carry out the steps of the methods set forth herein. The media and program code may be those specially designed and constructed for the purposes of the invention, or they may be of the kind well known and available to those having skill in the computer software arts. Examples of computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed is:

1. A leakage power recovery system, comprising:
a power recovery module configured to carry out an instance of an initial power recovery process in each of multiple scenarios concurrently, said initial power recovery process including making first conditional replacements of cells in at least one path in a circuit design with lower leakage cells and estimating a delay and a slack of said at least one path based on said first conditional replacements; and
a speed recovery module associated with said power recovery module and configured to carry out a speed recovery process in each of said multiple scenarios concurrently, said speed recovery process including determining whether said first conditional replacements cause a timing violation with respect to said at least one path and making second conditional replacements with higher leakage cells until said timing violation is removed.

2. The system as recited in claim 1 wherein said initial power recovery process further includes retrieving information regarding said cells from a Vₜ map file.

3. The system as recited in claim 1 wherein said initial power recovery process further includes employing a low effort level in which said cells and said slack are examined to determine if said cells can be conditionally replaced with said lower leakage cells without reducing said slack below a user-defined slack limit.

4. The system as recited in claim 1 wherein said initial power recovery process further includes employing a high effort level in which said cells are conditionally replaced with lowest leakage cells.

5. The system as recited in claim 1 wherein said initial power recovery process further includes exempting clock network cells and cells having transition or capacitance violations from said first conditional replacement.

6. The system as recited in claim 1 wherein said speed recovery process further includes making said second conditional replacements with respect to a minimum number of said cells to repair said timing violation.

7. The system as recited in claim 1 wherein said initial power recovery process further includes making said first conditional replacements using lower leakage cells having an equivalent footprint area.

8. The system as recited in claim 1 wherein said speed recovery process further includes employing crosstalk aggression as a cost factor in making said second conditional replacements.

9. The system as recited in claim 1 wherein said cells are of at least three celltypes.

10. The system as recited in claim 1 wherein said circuit design is an integrated circuit design.

11. The system as recited in claim 1 wherein said initial power recovery module and said speed recovery module are embodied in program code stored on a computer-readable medium.

12. A leakage power recovery method carried out in each of multiple scenarios concurrently, comprising:
making first conditional replacements of cells in at least one path in a circuit design with lower leakage cells;
estimating a delay and a slack of said at least one path based on said first conditional replacement;
determining whether said first conditional replacements cause a timing violation with respect to said at least one path;
making second conditional replacements with higher leakage cells until said timing violation is removed; and
merging and applying said swaps and updating timing with respect to said each of said multiple scenarios.

13. The method as recited in claim 12 further comprising retrieving information regarding said cells from a Vₜ map file.

14. The method as recited in claim 12 wherein said making said first conditional replacement comprises employing a low effort level in which said cells and said slack are examined to determine if said cells can be conditionally replaced with said lower leakage cells without reducing said slack below a user-defined slack limit.

15. The method as recited in claim 12 wherein said making said first conditional replacement comprises employing a high effort level in which said cells are conditionally replaced with lowest leakage cells.

16. The method as recited in claim 12 further comprising exempting clock network cells and cells having transition or capacitance violations from said first conditional replacement.

17. The method as recited in claim 12 wherein said making said second conditional replacements comprises making said second conditional replacements with respect to a minimum number of said cells to repair said timing violation.

18. The method as recited in claim 12 wherein said making said first conditional replacements comprises making said first conditional replacements using lower leakage cells having an equivalent footprint area.

19. The method as recited in claim 12 wherein said making said second conditional replacements comprises employing crosstalk aggression as a cost factor.

20. The method as recited in claim 12 wherein said cells are of at least three celltypes.
